(19) United States
(12) Patent Application Publication
(10) Pub. No.: US 2017/0240007 A1
(43) Pub. Date: Aug. 24, 2017

(54) Transmitter for Wireless Tire Pressure Monitoring System

(71) Applicant: Gofull Technology Co., Ltd., Hsinchu City (TW)

(72) Inventor: Hsiu-Ping Chuang, Hsinchu City (TW)

(21) Appl. No.: 15/274,980

(22) Filed: Sep. 23, 2016

(30) Foreign Application Priority Data
Feb. 23, 2016 (TW) 105202489

(51) Int. Cl. B60C 23/04; B60C 23/20

(52) U.S. Cl. CPC B60C 23/0452; B60C 23/20

(57) ABSTRACT

This invention relates to a transmitter for a wireless tire pressure monitoring system. The transmitter includes: an insulating housing including a top and a sidewall extending downward from the periphery of the top, wherein the interior surface of the top and the interior surface of the sidewall are configured to define a cavity; an antenna made of metal wire, wherein the antenna is provided on the top and the sidewall of the insulating housing and continuously extends along the top and the sidewall; and a wireless signal transmission assembly covered by the insulating housing and electrically connected to the antenna.

### CLAIM OF PRIORITY

This application claims the priority benefit of Taiwan Application Serial No. TW105202489, filed on Feb. 23, 2016. All disclosure thereof is incorporated herein by reference.

### BACKGROUND OF THE INVENTION

### A. Field of the Invention

This invention relates to a transmitter for a wireless tire pressure monitoring system (wireless TPMS).

### B. Description of the Prior Art

The tire pressure of a tire affects vehicle status significantly, and has a critical influence on driving safety. A tire should have proper tire pressure to allow the vehicle to travel smoothly. Tire pressure too high or too low may cause a flat tire, which seriously endangers driving safety. Therefore, it goes without saying that monitoring tire pressure is important for driving safety. For this reason, there has developed wireless tire pressure monitoring systems for monitoring the tire pressure in real time.

Conventionally, such a wireless tire pressure monitoring system comprises a receiver and a transmitter. The receiver is installed on or near the dashboard of a vehicle, so that at any time the driver can read the information of tire pressure and temperature transmitted from the transmitter installed inside the tire, thereby knowing the tire condition at any time. As depicted in FIG. 1, the transmitter is typically installed inside the tire and fixed to a rim 10. The transmitter comprises a printed circuit board 1, a wireless signal transmission device 3, an antenna 5, a battery 7, and a shell 9. The wireless signal transmission device 3 and antenna 5 are both directly disposed on the printed circuit board 1, and electrically connected to the printed circuit board 1. The printed circuit board 1 is covered by the shell 9 and electrically connected to the battery 7.

In addition, according to general design principle for an antenna, the length of the antenna is typically around a quarter of wavelength for the employed frequency. Because the frequency employed by a typical wireless tire pressure monitoring system is 315 MHz or 433 MHz, the length of the antenna is generally designed to be about 24 cm (corresponding to 315 MHz) or 17 cm (corresponding to 433 MHz). The antenna 5 is typically constituted by a coil, and should be directly soldered on the printed circuit board 1. It is difficult to dispose an antenna 5 with the aforementioned length inside the transmitter because the internal space of the transmitter is narrow. Even though an antenna 5 with the aforementioned length is managed to be positioned inside the transmitter, due to the crowded space, the antenna 5 may tend to cause self-interference, or cause short circuit or signal interference with other electrical assemblies in the transmitter. As such, the manufacturer of a wireless tire pressure monitoring system often chooses an antenna with length shorter than the aforementioned one; however, the wireless transmission efficiency may suffer.

Moreover, as depicted in FIG. 1, the printed circuit board 1 of the transmitter is disposed near the rim 10, so the distance between the antenna 5 and the rim 10 is short. The rim 10 is typically made of metal material, and thus has a shielding effect on the antenna, further impeding signal transmission of the antenna 5.

To solve the above problems, there has developed a transmitter combined with an air faucet of the tire. Such a transmitter utilizes the air faucet of the tire as an antenna. However, the structure of such a transmitter is complex, and production cost is high. Besides, because specifications of air faucets are not exactly the same, such a transmitter cannot be commonly used with various types of air faucets, which is inconvenient for a driver.

Therefore, there requires a transmitter for a wireless tire pressure monitoring system, the transmitter having sufficient antenna length and a simple structure.

### SUMMARY OF THE INVENTION

In view of the above problem, a transmitter for a wireless tire pressure monitoring system is provided according to an embodiment of the present invention, the transmitter comprising: an insulating housing, comprising a top and a sidewall extending downward from a periphery of the top, wherein an interior surface of the top and an interior surface of the sidewall are configured to define a cavity; an antenna made of metal wire, wherein the antenna is provided on the top and the sidewall of the insulating housing and continuously extends along the top and the sidewall, so that the antenna can extend to the most appropriate length and be located farther from the rim to avoid the shielding effect; and a wireless signal transmission assembly, covered by the insulating housing and electrically connected to the antenna.

The transmitter for a wireless tire pressure monitoring system of the present invention has the following advantages: increasing the length of the antenna as required, having a simple structure, having low production cost, commonly used with various types of air faucets, avoiding shielding effects of the rim, etc.

Other aspects and advantages of the invention will become apparent by reference to the following detailed description combined with the appended drawings for illustrating the principle examples of the invention. In addition, well-known devices and principles are not further described in the specification so as not to unnecessarily obscure the invention.

### BRIEF DESCRIPTION OF THE DRAWINGS

In the appended drawings of the invention, the same component is denoted by the same reference numeral.

FIG. 1 is a cross-sectional view schematically showing a conventional transmitter for a wireless tire pressure monitoring system;

FIG. 2 is an exploded view schematically showing a transmitter for a wireless tire pressure monitoring system according to an embodiment of the present invention;

FIG. 3 is a perspective view schematically showing the antenna in FIG. 2;

FIG. 4 is a cross-sectional view taken along line A-A of FIG. 2, and schematically shows the configuration of the insulating housing and the antenna of FIG. 2;

FIG. 5 shows a variation of the configuration of the insulating housing and antenna in FIG. 4; and

FIG. 6 shows another variation of the configuration of the insulating housing and antenna in FIG. 4.

### DETAILED DESCRIPTION OF THE PREFERRED EMBODIMENTS

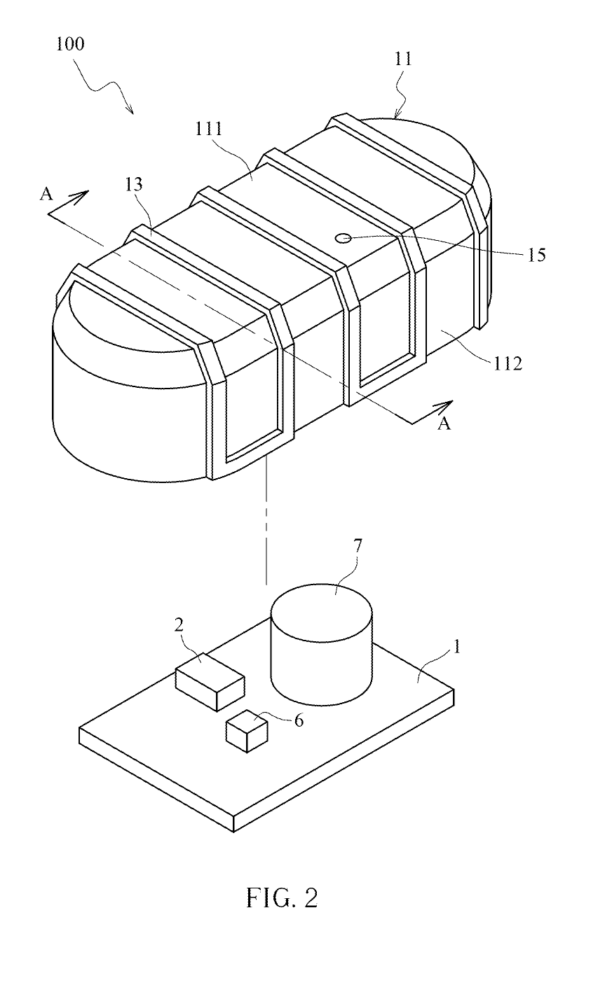

FIG. 2 is an exploded view schematically showing a transmitter 100 for a wireless tire pressure monitoring system according to an embodiment of the present invention. The transmitter 100 can comprise: an insulating housing 11, comprising a top 111 and a sidewall 112 extending downward from the periphery of the top 111; an antenna 13 made of metal wire, wherein the antenna 13 is provided on the top 111 and the sidewall 112 of the insulating housing 11 and continuously extends along the top 111 and the sidewall 112; and a wireless signal transmission assembly covered by the insulating housing 111 and electrically connected to the antenna 13. The insulating housing 11 is made of insulating material such as plastic. In an embodiment, for example, the insulating housing 11 can be made of Nylon, but is not limited thereto.

In the present invention, the wireless signal transmission assembly can comprise a printed circuit board 1, a wireless signal transmission device 2, and a battery 7. The wireless signal transmission device 2 is disposed on a printed circuit board 1 containing a microprocessor, and is electrically connected to the printed circuit board 1. The printed circuit board 1 is electrically connected to the battery 7. In an embodiment, for example, the wireless signal transmission device 2 can be a radio frequency (RF) signal transmission device, but is not limited thereto.

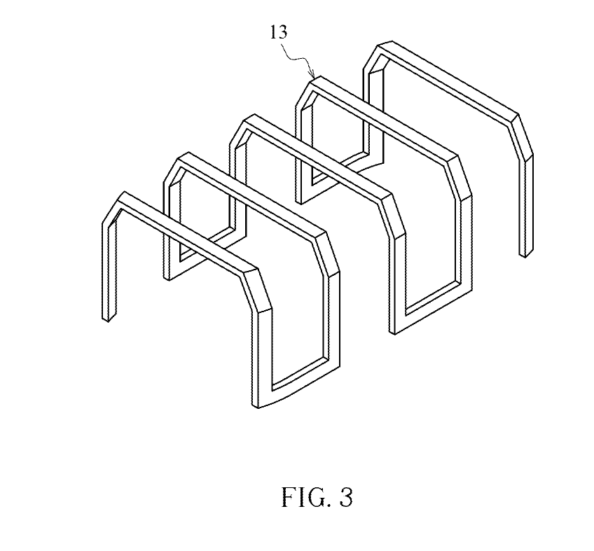

FIG. 3 is a perspective view, schematically showing the antenna 13 in FIG. 2. In an embodiment, the antenna 13 can be made of metal wire such as copper wire, etc., but is not limited thereto. In an embodiment, for instance, the antenna 13 can be electrically connected to the printed circuit board 1 of the wireless signal transmission assembly. For example, at least one end of the antenna 13 can be electrically connected to the printed circuit board 1 of the wireless signal transmission assembly, but is not limited thereto. In another embodiment, for instance, the antenna 13 can be electrically connected to the wireless signal transmission device 2 directly.

Furthermore, in an embodiment, the wireless signal transmission assembly can further comprise a pressure/temperature sensor 6. The pressure/temperature sensor 6 is disposed on the printed circuit board 1, and electrically connected to the printed circuit board 1. Because the printed circuit board 1 is electrically connected to the battery 7, the battery 7 can be utilized for supplying power to the printed circuit board 1, the wireless signal transmission device 2, and the pressure/temperature sensor 6.

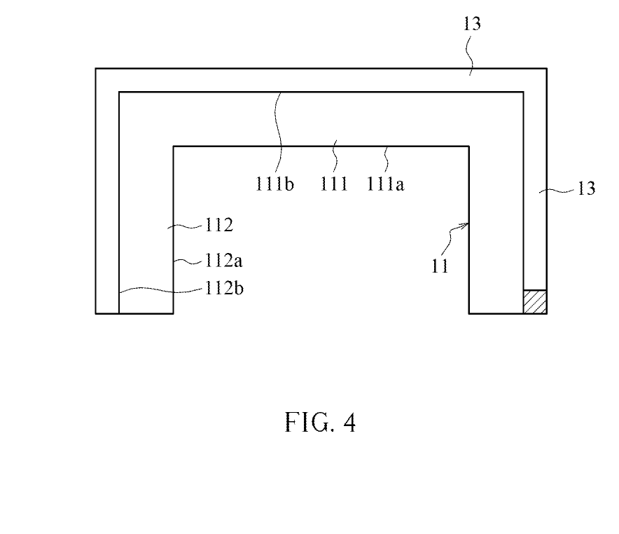

FIG. 4 is a cross-sectional view taken along line A-A of FIG. 2, and schematically shows the configuration of the insulating housing 2 and the antenna. As depicted in FIG. 4, an interior surface 111a of the top 111 and an interior surface 112a of the sidewall 112 of the insulating housing 11 can be configured to define a cavity. Also, as depicted in FIG. 2, the insulating housing 11 can further have an opening 15 in communication with the cavity, and the pressure/temperature sensor 6 of the wireless signal transmission assembly can detect the pressure and temperature inside the tire through the opening 15. Although the opening 15 showed in FIG. 2 is in the top 111 of the insulating housing 11, the opening 15 actually can be in the sidewall 112 of the insulating housing 11. The wireless signal transmission device 2 can be configured to transmit the information of pressure and temperature detected by the pressure/temperature sensor 6.

In the embodiments depicted in FIGS. 2 and 4, the antenna 13 can be disposed on an outer surface 111b of the top 111 and an outer surface 112b of the sidewall 112b, and continuously extends along the top 111 and the sidewall 112.

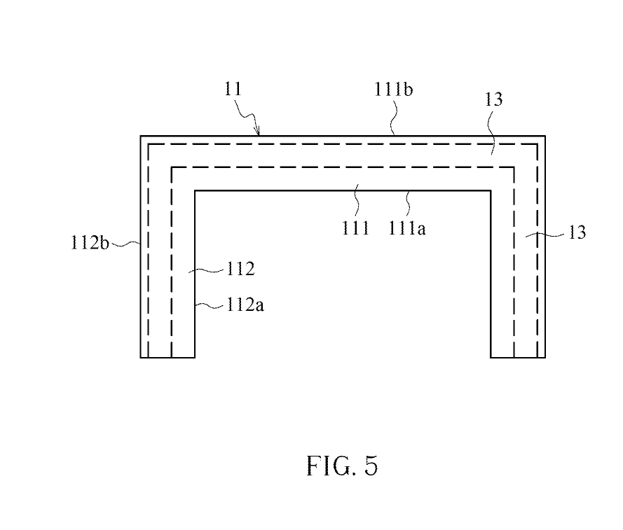

FIG. 5 shows a variation of the configuration of the insulating housing and antenna in FIG. 4. In the embodiment showed in FIG. 5, the antenna 13 can be partially or totally embedded into the top 111 and sidewall 112 of the insulating housing 11, and continuously extends along the top 111 and the sidewall 112.

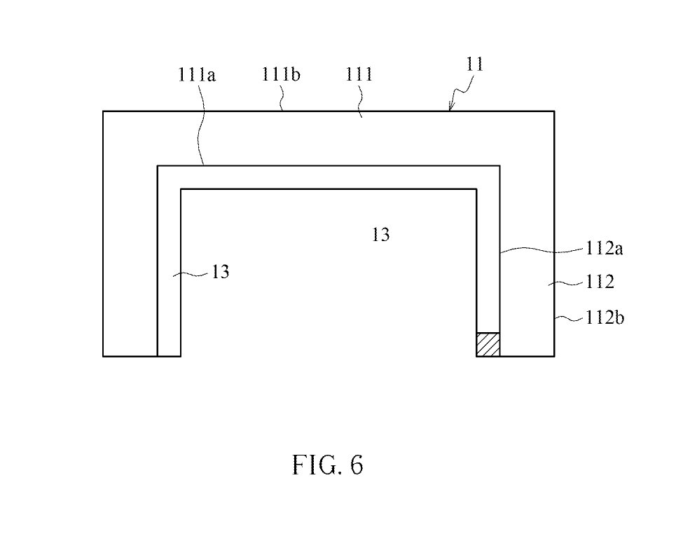

FIG. 6 shows another variation of the configuration of the insulating housing and antenna in FIG. 4. In the embodiment showed in FIG. 6, the antenna 13 can be disposed on the interior surface 111a of the top 111 and the interior surface 112a of the sidewall 112, and continuously extends along the top 111 and the sidewall 112.

In an embodiment of the present invention, the antenna 13 can configured to have a continuous winding shape so as to increase the length thereof. Of course, the antenna can configured to have other continuous shape, such as a continuous spiral shape, but is not limited thereto.

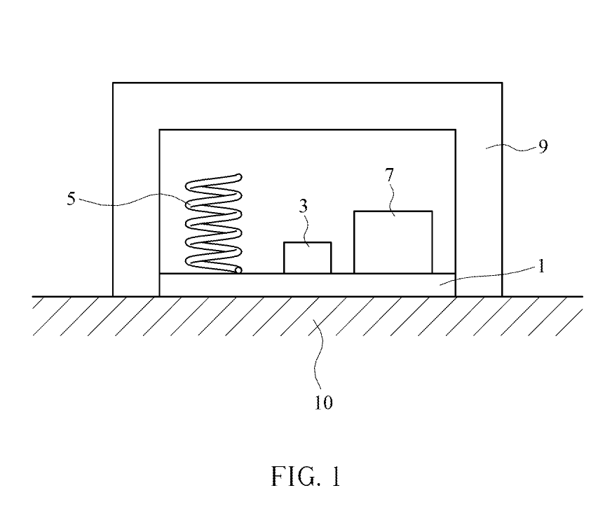

Furthermore, similar to the conventional transmitter showed in FIG. 1, the transmitter 100 of the present invention can be installed inside the tire in the same manner as depicted in FIG. 1, and fixed to the rim 10 made of metal material. Compared to the conventional transmitter showed in FIG. 1, the antenna 13 of the transmitter 100 of the present invention is farther from the rim 10 (because the antenna 13 is not disposed directly on the printed circuit board 1 but rather on the insulating housing 11), and thus is not likely affected by the shielding effect of the rim 10.

While the present invention has been shown and described by reference to preferred embodiments thereof, and in terms of the illustrative drawings, various possible modifications, alterations, and equivalent substitution could be conceived of by one skilled in the art without departing from the sprit and the scope of the present invention. However, such modifications, alterations, and substitutions still fall within the scope of the claims of the present invention.

What is claimed is:

1. A transmitter for a wireless tire pressure monitoring system, the transmitter comprising:
an insulating housing, comprising a top and a sidewall extending downward from a periphery of the top, wherein an interior surface of the top and an interior surface of the sidewall are configured to define a cavity;
an antenna made of metal wire, wherein the antenna is provided on the top and the sidewall of the insulating housing and continuously extends along the top and the sidewall; and
a wireless signal transmission assembly, covered by the insulating housing and electrically connected to the antenna.

2. The transmitter of claim 1, wherein the insulating housing has an opening in communication with the cavity, and the wireless signal transmission assembly comprises a pressure/temperature sensor, wherein the pressure/temperature sensor is configured to detect the pressure and temperature inside a tire through the opening.

3. The transmitter of claim 1, wherein the antenna is provided on an outer surface of the top and an outer surface of the sidewall.

4. The transmitter of claim 1, wherein the antenna is provided on the interior surface of the top and the interior surface of the sidewall.

5. The transmitter of claim 1, wherein the antenna is partially or totally embedded into the top and the sidewall.

6. The transmitter of claim 2, wherein the antenna is provided on an outer surface of the top and an outer surface of the sidewall.

7. The transmitter of claim 2, wherein the antenna is provided on the interior surface of the top and the interior surface of the sidewall.

8. The transmitter of claim 2, wherein the antenna is partially or totally embedded into the top and the sidewall.
